(19) United States
(12) Patent Application Publication
(10) Pub. No.: US 2006/0045462 A1
(43) Pub. Date: Mar. 2, 2006

(54) Methods and systems for operating a video recorder with a remote control unit

(76) Inventor: Thomas Poslinski, Elma, NY (US)

Correspondence Address: Steven L. Nichols;Rader, Fishman, & Grauer PLLC, River Park Corporate Center One, River Front Pkwy., Ste. 150, South Jordan, UT, 84095, US

(21) Appl. No.: 10/926,824

(22) Filed: Aug. 26, 2004

(51) Int. Cl. H04N 5/76

(52) U.S. Cl. 386/46; 386/69

(57) ABSTRACT

A remote control unit for a video recorder includes a transceiver for communicating with the video recorder; and a display device for displaying video programming. In some embodiments, the remote control unit receives a preview clip of a video program stored on the video recorder and displays that preview clip for a user of the remote control unit.

### BACKGROUND

In most video or home entertainment systems, a television or video monitor is used to watch broadcast and recorded television programming. The broadcast signal carrying the programming shown on the television set may come from, for example, a terrestrial antenna, a cable television system or a satellite dish. Modern users may have access to hundreds of channels of programming as well as pay-per-view service, video-on-demand service and other services.

In most such system, additional electronics are needed to allow the television set to access and display the variety of available programming. These additional electronics are typically incorporated into a terminal, known as a set-top box. The set-top box is connected to the television set and provides a programming signal for the television set to display. The set-top box is also connected to a signal source, for example, a cable television system or satellite dish, and processes a programming signal from that signal source into a form that can be used and displayed by the television set.

In addition to providing access to the programming from a cable or satellite service provider, a set-top box may also perform other functions for the user. For example, the set-top box may incorporate a video recorder that can record video programming for later playback as desired by a user.

Video recorders, whether incorporated into a set-top box or provided as a separate unit, allow a user to record and replay video and television programming. Modern video recorders store the recorded programming digitally on a mass data storage device, such as a hard drive. Such video recorders are known as Personal Video Recorders (PVRs) or Digital Video Recorders (DVRs).

### SUMMARY

A remote control unit for a video recorder includes a transceiver for communicating with the video recorder and a display device for displaying video programming. In some embodiments, the remote control unit receives a preview clip of a video program stored on the video recorder and displays that preview clip for a user of the remote control unit.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a diagram showing a video recorder and a remote control unit according to principles described herein.

FIG. 2 is an illustration of an exemplary remote control unit according to principles described herein.

FIG. 3 is another illustration of the remote control unit of FIG. 2, illustrating an exemplary user interface of the remote control unit.

FIG. 4 is another illustration of the remote control unit of FIG. 2, illustrating an exemplary video recorder user interface of the remote control unit.

FIG. 5 is another illustration of the remote control unit of FIG. 2, illustrating a preview portion of the user interface of the remote control unit.

FIG. 6 is a flowchart illustrating the exemplary user interface and operation of the remote control unit of FIG. 2 according to principles described herein.

Throughout the drawings, identical reference numbers designate similar, but not necessarily identical, elements.

### DETAILED DESCRIPTION

As used herein and in the following claims, the term “video recorder” will be broadly defined to mean any device for recording and/or outputting audiovisual, video or television programming. Examples of a video recorder including a Personal Video Recorder (PVR) or Digital Video Recorder (DVR), a Digital Versatile (Video) Disk (DVD) player or the like. The video recorder may be incorporated into a set-top box or may be a separate unit. As noted above, a set-top box can enable access to the various channels of television programming and other services offered by a service provider.

The term “television” or “television set” will be used to broadly refer to any television, video monitor or display device displaying audiovisual programming or other services under the control of a user. The term “service provider” will be understood to mean any party providing services to a set-top box or video recorder including, but not limited to, a terrestrial television broadcasting company, a cable television company or a satellite television company. The services of a service provider may include audiovisual or television programming, internet or Web access, video-on-demand, pay-per-view or other services.

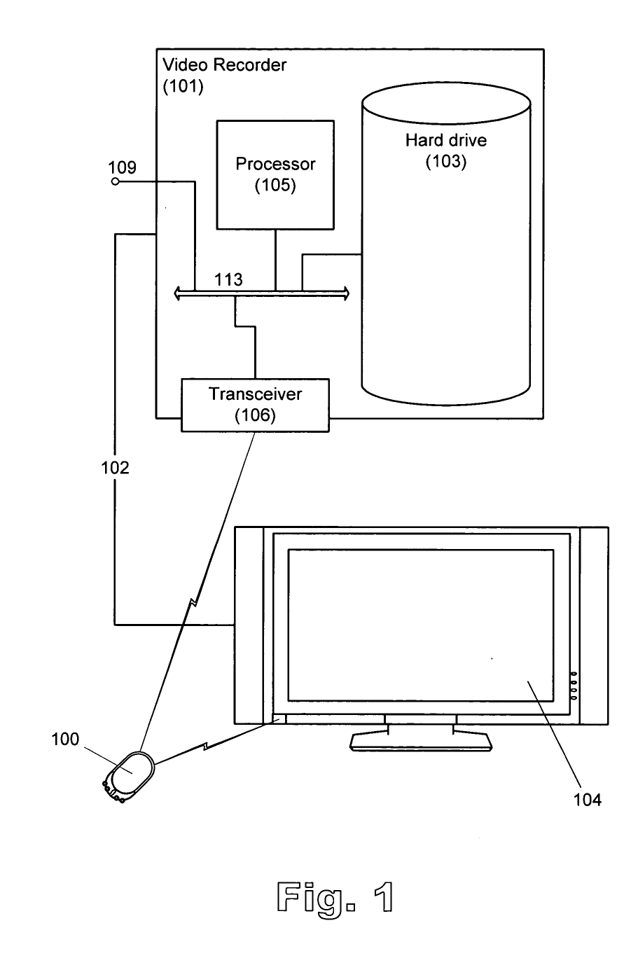

FIG. 1 is a diagram showing a video recorder with an exemplary remote control unit and television set according to principles described herein. As shown in FIG. 1, a video recorder (101) is connected to a television set (104) via a connection (102). This video recorder (101) may also be incorporated into a set-top box and/or have a connection (109) for receiving signals from a service provider. If the video recorder (101) is also functioning as a set-top box, a processor (105) in the video recorder (101) processes video signals from the service provider and outputs programming signals that can be displayed by the television set (104). The video recorder (101) may also provide access to other services from the service provider such as pay-per-view programming, video-on-demand programming, etc.

Additionally, the illustrated video recorder (101) can record and playback video programming as desired by a user. The video recorder (101) includes a data storage device, in the illustrated example, a hard drive (103), on which audiovisual programming can be recorded and from which recorded programming can be played back under control of the processor (105).

The video recorder (101) may be controlled using a remote control unit (100). As shown in FIG. 1, the remote control unit (100) can also be configured or programmed to control both the television (104) and the video recorder (101).

The video recorder (101) includes a transceiver or receiver (106) for communicating with the corresponding remote control unit (100). The television (104) will also include a transceiver or receiver for communicating with the remote control unit (100). The transceiver (106) of the video recorder (101) may be, for example, an infra-red receiver for receiving an infra-red signal from the remote control unit (100). In other examples, the transceiver (106) may be a radio-frequency receiver or some other wireless transceiver for communicating with the remote control unit (100). A system bus (113) interconnects the various components in the video recorder (101).

Over time, a large number of programs may be recorded and stored on the hard drive (103). The video recorder (101) will have a user interface that allows a user to view a list of the recorded programs and select a program that the use wishes to have played back. The selected program is then output by the video recorder (101) to the television set (104) and displayed on the television set (104).

Conventionally, the user interface of the video recorder (101) has included a remote control unit and a display on the connected television set. Thus, to select a recorded program for playback, the user would discontinue watching a program or other service on the television set and access the user interface of the video recorder (101). The user interface would then display a list of recorded programs on the television set form which the desired program can be selected. However, the user may desire to look through the list of recorded programs without discontinuing a program or service being displayed on the television set (104). In this past, this has not been possible.

However, according to principles described herein, the remote control unit (100) incorporates a display device which can be used to interface with the video recorder (101). The video recorder (101) transmits a list of recorded programs stored on the hard drive (103) to the remote control unit (100). The remote control unit (100) then displays the list of recorded programs and allows the user to scroll through the list.

If the user notes a program that he or she wishes to playback, the user can select that program on the remote control unit (100). The remote control unit (100) then signals the video recorder (101) to output that selected program to the television (104) for playback. In some instances, the user may want to view a clip of a recorded program before deciding whether to playback that program. In such a case, the remote control unit (100) signals the video recorder (101) for a clip of the recorded program. As will be described in more detail below, the video recorder (101) then transmits a clip of the recorded program to the remote control unit (100). The remote control unit (100) then displays the clip for the requesting user.

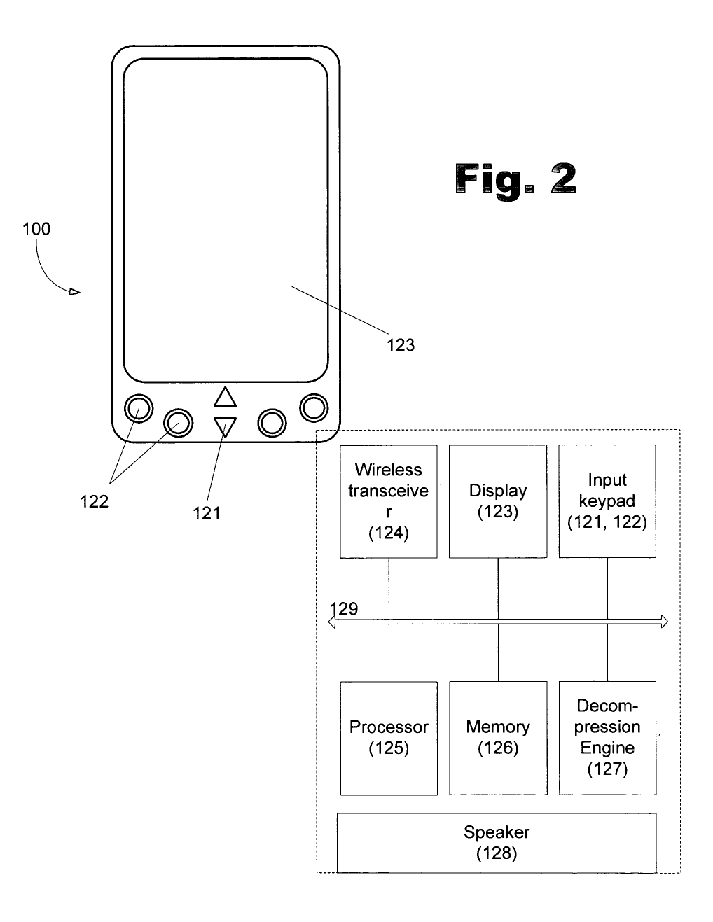

In addition, any feature of the user interface for the video recorder (101) can be controlled using the remote control unit (100) without interrupting the program or other service being displayed on the television set (104). The use of the remote control unit (100) to support the user interface of the video recorder (101) will now be described in further detail using FIGS. 2-6.

FIG. 2 is an illustration of an exemplary remote control unit according to principles described herein. FIG. 2 also illustrates the principal internal components of the remote control unit.

As shown in FIG. 2, the exemplary remote control unit (100) includes a display device (123). This display device (123) may be, for example, a liquid crystal display or other flat panel display device. The display device (123) may also be touch-sensitive so that it can display soft buttons or other controls that can be activated with a user's finger or a stylus or other object.

In some embodiments, the remote control unit (100) includes an input keypad (121, 122) for controlling the user interface elements displayed on the display device (123). This input keypad may include a number of buttons (122). These buttons (122) may be assigned dedicated functions such as turning power on or off for the video recorder or toggling the user interface between different screens or interface displays as will be described in more detail below. Some of the keypad buttons (121) may be used to scroll through a listing of recorded programs or other elements on the display device (123), while one of the other buttons (122) is used to select an indicated program or item that is highlighted on the display (123).

Internally, the exemplary remote control unit (100) includes the following principal components. Those of skill in the art will realize that more or less than the listed internal components may be incorporated into a remote control unit as described herein. This portion of the description will refer to the right hand portion of FIG. 2, which is a block diagram of the exemplary remote control unit (100) described herein.

As mentioned above, the exemplary remote control unit (100) includes a display device (123) and may include an input keypad (121, 122). The remote control unit (100) also includes a wireless transceiver (124) for communicating with the video recorder (101, FIG. 1) and/or other system components such as a television set (104, FIG. 1). As described in FIG. 1, the video recorder (101, FIG. 1) includes a corresponding wireless transceiver (106, FIG. 1) for communicating with the remote control unit (100). These wireless transceivers (106, 124) can communicate using any wireless signaling method.

The remote control unit (100) also incorporates a processor (125) and a memory unit (126). The memory unit (126) may be non-volatile memory and contains the programming or firmware for the remote control unit (100). The processor (125) will access and execute the firmware in the memory (126) to support all the features described herein as performed by the remote control unit (100). The various components of the remote control unit (100), including the processor (125) and memory (126) are interconnected by a system bus (129).

The remote control unit (100) may also include a decompression engine (127) including decoding and/or decompression circuits or firmware for handling video, audio or audiovisual signals received from the video recorder (101, FIG. 1) or other system components. The decompression engine (127) may be implemented as hardware, firmware or software, or a combination thereof. As mentioned above, the remote control unit (100) may receive a transmission of a clip of a recorded audiovisual or television program that is then displayed on the display device (123). The signal from the video recorder bearing the audiovisual programming is decompressed and/or decoded by the decompression engine (127) for display on the display device (123).

The remote control unit (100) may also include a speaker (128) for outputting an audio signal that corresponds to a clip of audiovisual programming being shown on the display device (123). The speaker (128) may also be used to output other sounds as part of the user interface or operation of the remote control unit (100).

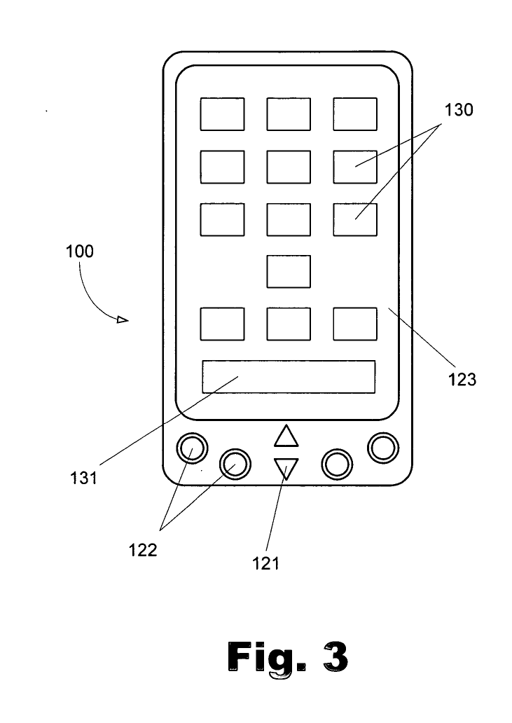

FIG. 3 is another illustration of the remote control unit of FIG. 2, illustrating an exemplary user interface of the remote control unit. As shown in FIG. 3, the exemplary remote control unit (100) may, in one mode of operation, display a number of soft buttons (130) on a touch-sensitive display device (123). These buttons (130) can be activated with a user's finger, a stylus or other object by applying pressure to the area of the display device (123) where the particular button being activated is displayed.

FIG. 3 illustrates an exemplary standard user interface screen displayed on the display device (123). In the standard user interface screen, the soft buttons (130) will have a particular organization and designated functions. For example, some of the soft buttons (130) may be organized into a ten-digit keypad so that a particular channel number to be tuned, a personal identification number or other number, can be input. In some instances, the soft buttons (130) may be organized into a full alphanumeric keypad for the entry of alphanumeric data. Some of the soft buttons (130) may be organized into function keys such as “pause/play,” “stop,” “fast forward,” “rewind,” etc. These functions may also be assigned to the buttons (122) of the remote control unit (100).

The exemplary remote control unit (100) may also have other user interface screens used to control other functions of the video recorder and/or other system components. The soft buttons (130) may include a button or buttons for switching the display to another of the user interface screens available. For example, button (131) may switch the display to a user interface screen for controlling the video recorder as will be described below. The hard buttons (122) of the remote control unit (100) may also be assigned to switch the display on the display device (123) among various user interface screens as described herein.

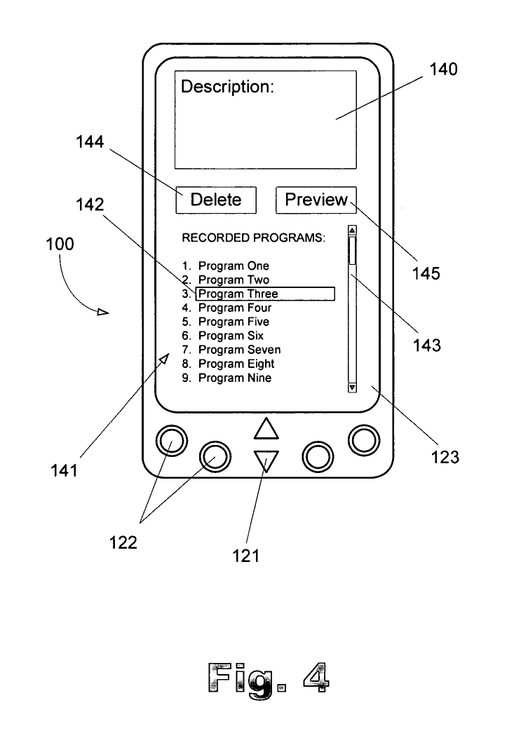

FIG. 4 is another illustration of the remote control unit of FIG. 2. FIG. 4 illustrates another exemplary user interface screen that can be displayed on and operated unit the remote control unit (100). As shown in FIG. 4, for this user interface screen, the display device (123) displays a listing (141) of recorded programs stored on the video recorder (101, FIG. 1). As mentioned above, this listing is transmitted from the video recorder to the remote control unit using, for example, the wireless interface created between the transceivers of the video recorder and remote control unit.

This listing (141) may include a scroll bar (143) to indicate the length of the full listing and the relative location in the full listing of the partial list then displayed on the display (123). The listing of recorded programs (141) will also include a highlight, cursor, box or other indicator (142) that indicates one of the programs in the list (141).

When a particular program is indicated, e.g., Program Three in FIG. 4, by the indicator (142), a description (140) of that program may be displayed on the user interface screen. This description (140) may have been taken from an electronic program guide, the Internet or some other source, or input by the user in connection with the recorded program. The description (140) may include, for example, a synopsis of, year of creation for, and principal actors in the indicated program, e.g., Program Three. The description (140) may be transmitted to the remote control unit (100) by the video recorder (101, FIG. 1).

The user can scroll the indicator (142) through the listing using, for example, buttons (121) on the remote control unit (100), a jog dial or other user input device. The user can also move the indicator (142) to select a particular program by tapping the title of that program in the listing (141) with a finger, stylus or other object. Once a program is indicated (e.g., Program Three in FIG. 4), that program can be selected for playback by pressing a button (122) of the remote control unit, pressing a soft “playback” button on the display (123) or by tapping the title for that program in the listing (141).

The user interface screen of FIG. 4 may also include a soft (144) or hard button for deleting the indicated program. For example, if the soft “delete” button (144), shown in FIG. 4, is activated, the indicated program will be deleted from the video recorder (101). In some embodiments, if the soft “delete” button (144) is activated, the user interface will prompt the user to confirm the command to delete the indicated program. If the user does not confirm the delete command, the user interface will return to the display shown in FIG. 4. However, if the user confirms the delete command, the remote control unit (100) will transmit a command to the video recorder (101, FIG. 1) to delete the indicated program.

The user interface screen of FIG. 4 may also include a soft (145) or hard button for previewing the indicated program. For example, if the soft “preview” button (145), shown in FIG. 4, is activated, the remote control unit (100) will signal the video recorder (101, FIG. 1) to prepare and transmit a clip of the indicated program. The remote control unit (100) will then receive the transmitted clip and display the program clip, with or without accompanying audio.

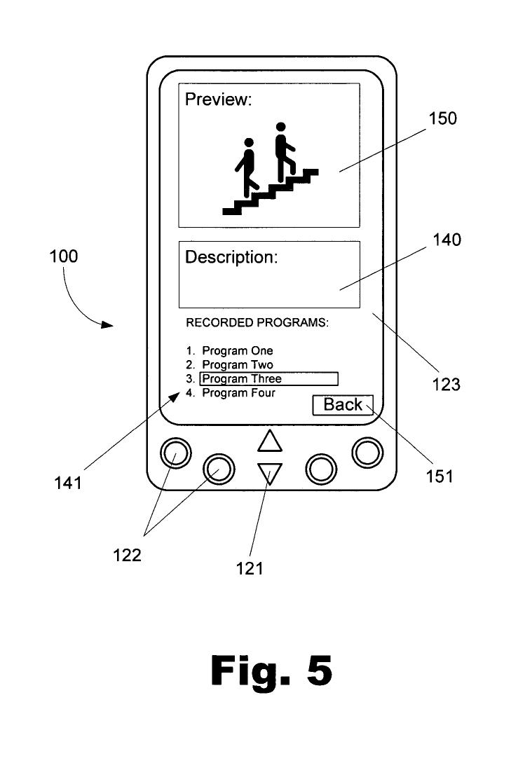

FIG. 5 is another illustration of the remote control unit of FIG. 2, illustrating a preview portion of the user interface of the remote control unit. As shown in FIG. 5, when the user signals for a preview of a recorded program, a clip of the indicated program is display in a preview window (150) of the user interface on the display device (123) of the remote control unit (100).

The preview may or may not include accompanying audio. As described above, the remote control unit (100), in some embodiments, will include a speaker for producing or outputting audio associated with a preview video clip being shown on the display (123) of the remote control unit (100).

The preview screen of the user interface shown in FIG. 5 may also include a soft (151) or hard button for terminating the preview being shown and returning to, for example, the user interface screen illustrated in FIG. 4. In some embodiments, the user interface may automatically revert to the interface screen of FIG. 4 as soon as the preview clip has been shown. Additionally, the buttons on the remote control (122) or corresponding soft buttons on the display (123) can be used to replay, fast forward, reverse/rewind, pause or stop the preview clip being shown in the preview window (150) of the remote control unit (100).

As should be noted again, all the functionality of the remote control unit (100) described herein can be performed without interrupting a program or other service being displayed on a television set (104, FIG. 1) of the system. The television or other video monitor can continue to display another program or service while the user uses the remote control unit described herein to look for and preview desired recorded programming. Only when a recorded program has been selected for playback does the video recorder (101, FIG. 1) interrupt the program or service on the television (104, FIG. 1) to output the selected recorded program.

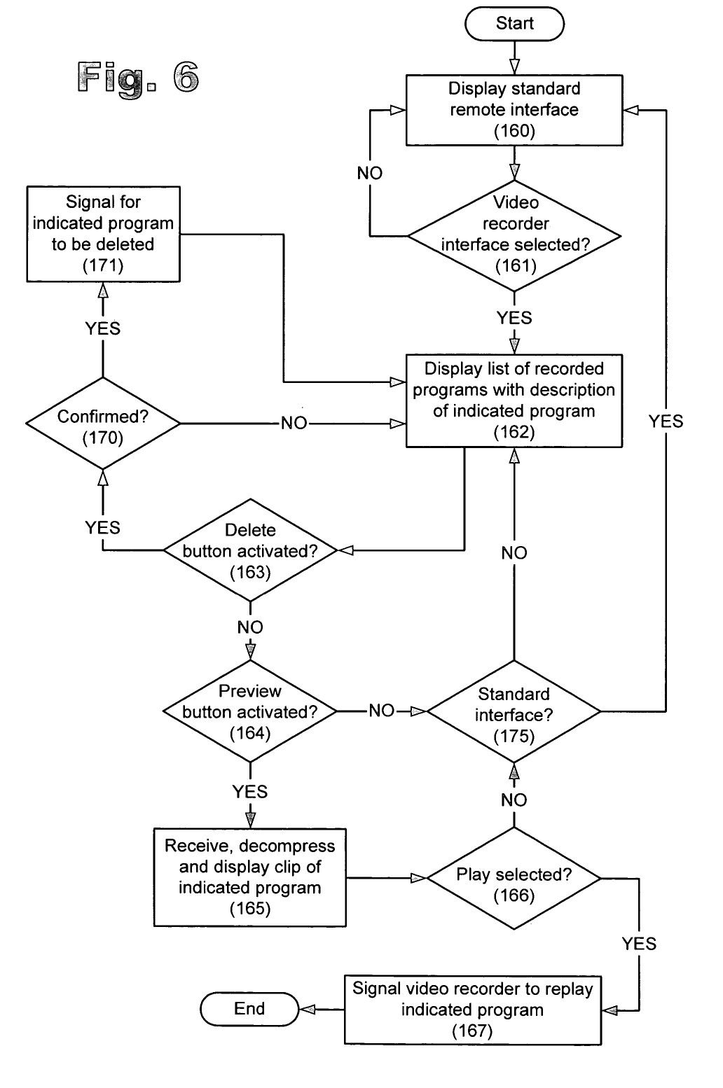

FIG. 6 is a flowchart illustrating the exemplary user interface and operation of the remote control unit described herein. As shown in FIG. 6, the remote control unit may default to a standard user interface screen (step 160) when activated. An example of this standard user interface screen is illustrated in FIG. 3 and described above.

At some point, the user may switch the display to a video recorder interface (determination 161) such as the example shown in FIG. 4 and described above. This screen can be used to display a list of the recorded programs (step 162). This listing may provide a description of a program indicated from the list as described above.

If the user desires to delete a program from the video recorder (determination 163), the user can indicate the program to be deleted in the list on the remote control unit and then activate a “delete” button of the user interface. The user may be asked to confirm the delete command (determination 170). If the delete command is confirmed, the remote control unit signals the video recorder to delete the indicated program (step 171). If the delete command is not confirmed, the user interface returns to the display of the list of recorded programs.

The user may also use the interface to preview a clip of a recorded program. A “preview” button may be activated to initiate the preview of an indicated program (determination 164). The remote control unit then signals the video recorder to transmit a clip from the indicated program.

The video recordings may be compressed for storage on the video recorder using, for example, the MPEG-2 (Motion Pictures Expert Group) compression scheme. In some embodiments, the video recorder may further compress a video clip from the stored program for transmission to the remote control unit. Given a limited bandwidth for transmission between the video recorder and the remote control unit, further compression of the video being transmitted or streamed to the remote control unit will speed up the preview feature described herein. For example, the video clip to be previewed on the remote control unit may be compressed according to the MPEG-4 standard for transmission to the remote control unit.

When received in the remote control unit (step 165), the signal for the video clip is decompressed by the decompression engine (127, FIG. 2) and displayed on the display device of the remote control unit (100, FIG. 2). As described above, the remote control unit can implement any trick modes for the preview, allowing the user to skip ahead or replay, fast forward, reverse, or pause the preview. These commands for the preview can be implemented by signaling the video recorder to accordingly alter the stream of the preview signal to the remote control unit. For example, if the user wants to rewind the preview, the remote control signals the video recorder to reverse the stream of video frames being streamed to the remote control unit. If the user wants to fast forward the preview, the remote control signals the video recorder to skip frames in the preview clip as sent to the remote control unit. The frame rate of transmission to the remote control unit remains constant, but the effect of the skipped frames is a fast forwarding of the preview as displayed on the remote control unit. Frames may also be skipped in a rewind/reverse operation.

After the user has viewed the preview clip, the user may decide to playback the recorded program from which the preview clip was taken. If playback is selected (determination 166), a signal is sent to the video recorder to replay the indicated program (step 167). If the user does not want to play the previewed program, the user can return to the standard interface screen (determination 175) or the video recorder interface (step 162).

In addition, the remote control unit (100, FIG. 1) described herein can be used to control other functions and features of a video recorder (101, FIG. 1) or other system components, such as the television (104, FIG. 1). For example, if the video recorder is connected to a network with other devices, the remote control unit can be used to transfer audiovisual files between networked devices. The remote control unit can be used to browse content available from other networked devices and/or a service provider such as the Internet and control the video recorder to acquire and store desired content. The remote control unit can also be used to edit audiovisual files on the video recorder to, for example, remove commercials or truncate the recorded programming.

As used herein and in the appended claims, the term “controls” shall refer broadly to the soft buttons, the hard buttons, the jog dial, and touch-sensitive screen described herein, as well as to any other user input devices that can be incorporated into a remote control unit or video recorder to operate, or give commands through, a user interface.

As will be appreciate by those skilled in the art, a personal digital assistant (PDA) may be programmed to function as the remote control unit described herein. Thus, the present specification includes the possibility of programming a PDA to function as a remote control unit that controls a video recorder to, for example, view a listing of recorded programming and preview clips of those recorded programs as desired by a user.

The preceding description has been presented only to illustrate and describe embodiments of the invention. It is not intended to be exhaustive or to limit the invention to any precise form disclosed. Many modifications and variations are possible in light of the above teaching. It is intended that the scope of the invention be defined by the following claims.

What is claimed is:

1. A remote control unit for a video recorder comprising:
a transceiver for communicating with said video recorder; and
a display device for displaying video programming.

2. The remote control unit of claim 1, further comprising
a user interface, portions of which are displayed on said display device,
wherein said user interface comprises is configured to receive a listing of programs recorded and stored on said video recorder and display said listing on said display device.

3. The remote control unit of claim 2, wherein said user interface comprises controls for indicating a particular program in said listing.

4. The remote control unit of claim 3, wherein said user interface comprises a description of a program indicated in said listing of programs.

5. The remote control unit of claim 3, wherein said user interface comprises controls for deleting a particular program in said listing from said video recorder.

6. The remote control unit of claim 3, wherein said user interface comprises controls for viewing a preview clip from a particular program in said listing, wherein said clip is received from said video recorder and displayed on said display device.

7. The remote control unit of claim 6, further comprising a speaker for outputting an audio signal associated with said clip received from said video recorder.

8. The remote control unit of claim 6, further comprising a decompression engine to decompress a signal bearing said clip received from said video recorder before said clip is displayed on said display device.

9. The remote control unit of claim 6, wherein said user interface comprises controls for controlling display of said preview clip so as to pause, fast-forward or rewind/reverse said preview clip.

10. The remote control unit of claim 6, wherein said user interface comprises controls for discontinuing display of said preview clip.

11. The remote control unit of claim 3, wherein said user interface further comprises controls for selecting said particular program indicated in said listing to cause said video recorder to playback said particular program.

12. The remote control unit of claim 2, wherein said listing of programs further comprising a scroll bar for indicating a total length of said listing and a portion of said listing being displayed within said total length of said listing.

13. The remote control unit of claim 1, further comprising a user interface on said remote control unit with controls for deleting a particular recorded program stored on said video recorder.

14. The remote control unit of claim 1, wherein said display device displays a preview clip taken from a particular video program stored on said video recorder, wherein said clip is received from said video recorder and displayed on said display device.

15. The remote control unit of claim 14, further comprising a speaker for outputting an audio signal associated with said clip received from said video recorder.

16. The remote control unit of claim 14, further comprising a decompression engine to decompress a signal bearing said preview clip received from said video recorder before said clip is displayed on said display device.

17. The remote control unit of claim 14, wherein remote control unit further comprises a user interface that includes controls for controlling display of said preview clip so as to pause, fast-forward or rewind/reverse said preview clip.

18. The remote control unit of claim 14, wherein said preview clip is displayed on said remote control unit with interrupting video programming or other service being output by said video recorder to a television set.

19. A method of controlling a video recorder using a remote control unit comprising:
receiving a transmission of a video program from said video recorder; and
displaying said video program on a display device of said remote control unit.

20. The method of claim 19, further comprising
receiving a listing of video programs recorded and stored on said video recorder; and
display said listing on said display device.

21. The method of claim 20, further comprising indicating a particular program in said listing.

22. The method of claim 21, further comprising displaying a description of a program indicated in said listing of programs on said display device.

23. The method of claim 21, further comprising deleting a particular program in said listing from said video recorder using said remote control unit.

24. The method of claim 19, further comprising:
receiving a preview clip taken from a particular video program stored on said video recorder; and
displaying said preview clip on said display device.

25. The method of claim 24, further comprising outputting an audio signal associated with said preview clip with a speaker of said remote control unit.

26. The method of claim 24, further comprising decompressing a signal bearing said preview clip received from said video recorder before said clip is displayed on said display device.

27. The method of claim 19, further comprising decompressing a signal bearing said video program before said video program is displayed on said display device.

28. The method of claim 24, further comprising controlling display of said preview clip so as to pause, fast-forward or rewind/reverse said preview clip.

29. The method of claim 24, further comprising discontinuing display of said preview clip.

30. The method of claim 19, further comprising:
displaying a listing of programs stored on said video recorder on said display device of said remote control unit; and
selecting a particular program indicated in said listing to cause said video recorder to playback said particular program.

31. The method of claim 19, wherein said video program is displayed on said remote control unit with interrupting video programming or other service being output by said video recorder to a television set.

32. A video recorder comprising:
a data storage unit for storing recorded video programming;
a processor for controlling operation of said video recorder;
a remote control unit; and
a first transceiver for communicating with said remote control unit;
wherein said remote control unit comprises
a second transceiver for communicating with said video recorder; and
a display device for displaying video programming received wirelessly from said video recorder.

33. The video recorder of claim 32, wherein said remote control unit further comprises:
a user interface, portions of which are displayed on said display device,
wherein said user interface comprises is configured to receive a listing of programs recorded and stored on said video recorder and display said listing on said display device.

34. The video recorder of claim 32, further comprising a user interface on said remote control unit with controls for deleting a particular recorded program stored on said video recorder.

35. The video recorder of claim 32, wherein said video recorder is configured to transmit to said remote control unit a preview clip taken from a particular video program stored on said video recorder, wherein said clip is received from said video recorder and displayed on said display device of said remote control unit.

36. The video recorder of claim 35, wherein said video recorder compresses said preview clip prior to transmission to said remote control unit.

37. The video recorder of claim 36, wherein said video recorder compresses said preview clip according to the MPEG-4 standard.

38. The video recorder of claim 36, wherein said remote control unit further comprising a decompression engine to decompress a signal bearing said preview clip received from said video recorder before said clip is displayed on said display device.

39. The video recorder of claim 35, wherein remote control unit further comprises a user interface that includes controls for controlling display of said preview clip so as to pause, fast-forward or rewind/reverse said preview clip.

40. The video recorder of claim 35, wherein said preview clip is displayed on said remote control unit with interrupting video programming or other service being output by said video recorder to a television set.

41. A remote control unit for controlling a video recorder, said remote control unit comprising:
means for receiving a transmission of a video program from said video recorder; and
means for displaying said video program on a display device of said remote control unit.
